(19) United States
(12) Patent Application Publication
(10) Pub. No.: US 2019/0283321 A1
(43) Pub. Date: Sep. 19, 2019

(54) Manufacturing Method Of Three-Dimensional Formed Object And Forming Apparatus Of Three-Dimensional Formed Object

(71) Applicant: Seiko Epson Corporation, Tokyo (JP)

(72) Inventors: Shunsuke MIZUKAMI, Hokuto (JP); Satoshi YAMAZAKI, Matsumoto (JP); Kazuhide NAKAMURA, Asahi (JP); Kohei YUWAKI, Shiojiri (JP); Koichi SAITO, Matsumoto (JP)

(21) Appl. No.: 16/299,574

(22) Filed: Mar. 12, 2019

(30) Foreign Application Priority Data
Mar. 13, 2018 (JP) 2018-045414

(51) Int. Cl. B29C 64/241; B29C 64/118; B29C 64/209; B33Y 10/00; B33Y 30/00

(52) U.S. Cl. CPC B29C 64/241; B29C 64/118; B33Y 30/00; B33Y 10/00; B29C 64/209

(57) ABSTRACT

A manufacturing method of a three-dimensional formed object includes a first step of causing a forming material to be deposited on a forming table to form a first formed part including a recessed portion which is open in a direction heading from the forming table toward a nozzle through a discharging process of supplying a material to a flat screw to generate the forming material in which the material is melted and discharging the forming material from the nozzle toward the forming table, and a second step including a step of causing the forming material to be deposited inside the recessed portion through the discharging process and forming a second formed part which is fixed to an inside of the recessed portion in a shorter forming time per unit volume than a forming time per unit volume of the first formed part.

This application claims priority under 35 U.S.C. § 119 to Japanese Patent Application No. 2018-045414 filed on Mar. 13, 2018, the entire disclosure of which is expressly incorporated by reference herein.

### BACKGROUND

### 1. Technical Field

The present invention relates to a manufacturing technique of a three-dimensional formed object.

### 2. Related Art

For example, JP-A-2017-88967 discloses a manufacturing method of forming a three-dimensional formed object by discharging a material from an ink jet head and curing the material. In the technique of JP-A-2017-88967, in order to swiftly form the three-dimensional formed object while increasing the forming precision, a support layer which determines a contour of the three-dimensional formed object is formed at high precision and a configuration layer which does not require precision is swiftly formed in a state of being supported by the support layer.

JP-A-2017-88967 merely discloses a technique of discharging a material which is prepared in a fluid state using an ink jet system. JP-A-2017-88967 does not consider swiftly forming the three-dimensional formed object at a high forming precision using a material which is prepared in a solid state using simpler steps and configurations.

### SUMMARY

According to an aspect of the invention, a manufacturing method of a three-dimensional formed object includes a first step of causing a forming material to be deposited on a forming table to form a first formed part including a recessed portion which is open in a direction heading from the forming table toward a nozzle through a discharging process of supplying a material to a rotating flat screw to generate the forming material in which at least a portion of the material is melted and discharging the forming material from the nozzle toward the forming table while changing a relative position between the forming table and the nozzle, and a second step, including a step of causing the forming material to be deposited inside the recessed portion through the discharging process, of forming a second formed part which is fixed to the inside of the recessed portion in a shorter forming time per unit volume than a forming time per unit volume of the first formed part.

### BRIEF DESCRIPTION OF THE DRAWINGS

The invention will be described with reference to the accompanying drawings, wherein like numbers reference like elements.

FIG. 1 is a schematic diagram illustrating the configuration of a forming apparatus of a first embodiment.

FIG. 2 is a schematic perspective view illustrating the configuration of a flat screw.

FIG. 3 is a schematic plan view illustrating the configuration of a screw surface facing portion.

FIG. 4 is a schematic diagram schematically illustrating a state of forming according to a discharging process.

FIG. 5 is an explanatory diagram illustrating a flow of a manufacturing step of a three-dimensional formed object in the first embodiment.

FIG. 6A is a schematic diagram illustrating an example of a first formed part which is formed in a first step.

FIG. 6B is a schematic diagram illustrating an example of a second formed part which is formed in a second step.

FIG. 7A is a schematic diagram illustrating a first example of a movement path of a nozzle during forming of the second formed part.

FIG. 7B is a schematic diagram illustrating a second example of a movement path of a nozzle during forming of the second formed part.

FIG. 7C is a schematic diagram illustrating a third example of a movement path of a nozzle during forming of the second formed part.

FIG. 8 is a schematic diagram schematically illustrating a state of a forming material when the forming material is discharged from the nozzle onto a planned part.

FIG. 9 is an explanatory diagram illustrating a flow of a manufacturing step of a three-dimensional formed object in a second embodiment.

FIG. 10 is an explanatory diagram illustrating a flow of a manufacturing step of a three-dimensional formed object in a third embodiment.

FIG. 11 is a schematic diagram illustrating the configuration of a forming apparatus of a fourth embodiment.

FIG. 12 is an explanatory diagram illustrating a flow of a manufacturing step of a three-dimensional formed object in the fourth embodiment.

FIG. 13 is a schematic diagram illustrating the configuration of a forming apparatus of a fifth embodiment.

FIG. 14 is an explanatory diagram illustrating a flow of a manufacturing step of the three-dimensional formed object in the fifth embodiment.

FIG. 15 is a schematic diagram for describing a step of forming a second formed part in the fifth embodiment.

### DESCRIPTION OF EXEMPLARY EMBODIMENTS

### 1. First Embodiment

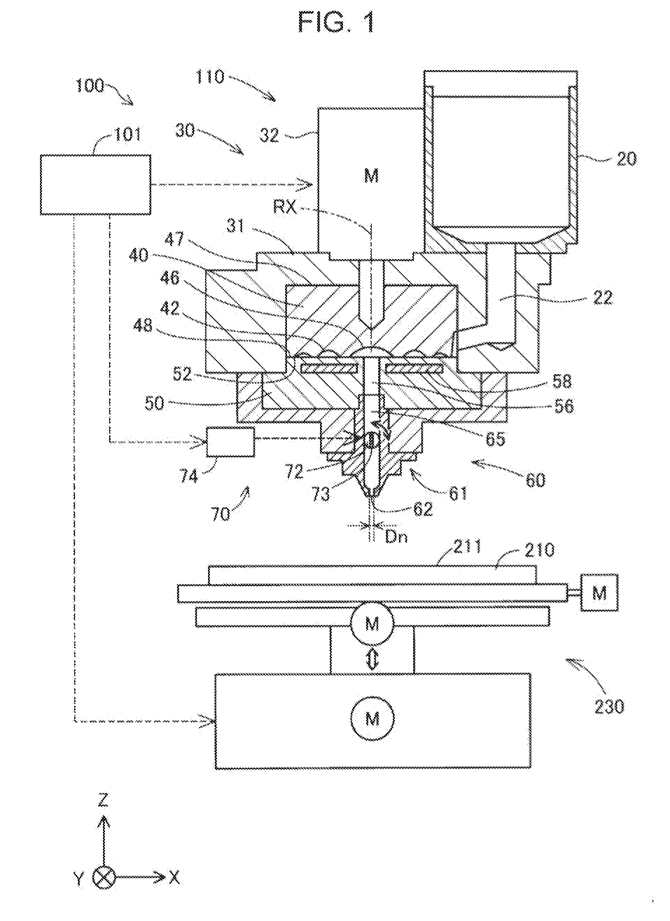

FIG. 1 is a schematic diagram illustrating the configuration of a three-dimensional forming apparatus 100 which executes the manufacturing method of a three-dimensional formed object in the first embodiment. In FIG. 1, arrows are depicted indicating X, Y, and Z directions which orthogonally intersect each other. In the first embodiment, the X direction and the Y direction are directions which are parallel to a horizontal plane, and the Z direction is an opposite direction from a gravity direction (a vertical direction). The arrows indicating the X, Y, and Z directions are also depicted, as appropriate, in the other reference drawings such that the depicted directions correspond to those of FIG. 1.

The three-dimensional forming apparatus 100 forms a three-dimensional formed object by depositing a forming material. Hereinafter, “the three-dimensional forming apparatus” will also be referred to as simply “the forming apparatus” and the three-dimensional formed object will also be referred to as simply “the formed object”. A description will be given of “the forming material” later. The forming apparatus 100 is provided with a control unit 101, a forming unit 110, a forming table 210, and a movement mechanism 230.

The control unit 101 controls the overall operation of the forming apparatus 100 and executes forming steps of forming the formed object. In the first embodiment, the control unit 101 is configured by a computer which is provided with one or a plurality of processors and a main memory device. The control unit 101 exhibits various functions by the processor executing a program or commands which are read onto the main memory device. The control unit 101 may be realized by a configuration in which a plurality of circuits for realizing each function are combined instead of configuring the control unit 101 using a computer.

The forming unit 110 disposes a forming material, which is obtained by melting at least a portion of a solid-state material to render the material paste form, on the forming table 210. The forming unit 110 is provided with a material supply unit 20, a forming material generating unit 30, and a discharging unit 60.

The material supply unit 20 supplies the material to the forming material generating unit 30. The material supply unit 20 is configured by a hopper which stores the material, for example. The material supply unit 20 includes a discharge port on the bottom of the material supply unit 20. The discharge port is connected to the forming material generating unit 30 via a communicating path 22. The material is inserted into the material supply unit 20 in a state such as pellets or a powder. The material which is input into the material supply unit 20 will be described later.

The forming material generating unit 30 generates a fluid paste-form forming material which is obtained by melting at least a portion of a material which is supplied from the material supply unit 20 and guides the forming material to the discharging unit 60. The forming material generating unit 30 includes a screw case 31, a drive motor 32, a flat screw 40, and a screw surface facing portion 50.

The flat screw 40 has a substantially columnar shape in which the height in the axial direction, which is a direction along the center axis, is smaller than the diameter. The flat screw 40 is disposed such that the axial direction is parallel to the Z direction and the flat screw 40 rotates along a circumferential direction. In the first embodiment, the center axis of the flat screw 40 matches a rotational axis RX of the flat screw 40. In FIG. 1, the rotational axis RX of the flat screw 40 is depicted using a dot-dash line.

The flat screw 40 is stored inside the screw case 31. A top surface 47 side of the flat screw 40 is connected to the drive motor 32 and the flat screw 40 rotates inside the screw case 31 due to a rotational driving force which is generated by the drive motor 32. The drive motor 32 is driven under the control of the control unit 101.

In the flat screw 40, groove portions 42 are formed in a bottom surface 48 which is a surface which intersects the rotational axis RX. The communicating path 22 of the material supply unit 20 which is described above is connected to the groove portions 42 from the side surface of the flat screw 40.

The bottom surface 48 of the flat screw 40 faces a top surface 52 of the screw surface facing portion 50 and a space is formed between the groove portions 42 of the bottom surface 48 of the flat screw 40 and the top surface 52 of the screw surface facing portion 50. In the forming unit 110, the material is supplied from the material supply unit in the space between the flat screw 40 and the screw surface facing portion 50. A description will be given later of the specific configuration of the flat screw 40 and the groove portions 42.

A heater 58 for heating the material is embedded in the screw surface facing portion 50. At least a portion of the material which is supplied into the groove portions 42 of the flat screw 40 which is rotating flows along the groove portions 42 while being melted and is guided to a center portion 46 of the flat screw 40 according to the rotation of the flat screw 40. The paste-form material which flows into the center portion 46 is supplied to the discharging unit 60 as the forming material via a communicating hole 56 which is provided in the center of the screw surface facing portion 50.

The discharging unit 60 includes a nozzle 61, a flow path 65, and an opening-closing mechanism 70. The nozzle 61 is connected to the communicating hole 56 of the screw surface facing portion 50 through the flow path 65. The flow path 65 is a flow path of the forming material between the flat screw 40 and the nozzle 61. The nozzle 61 discharges the forming material which is generated in the forming material generating unit 30 toward the forming table 210 from a discharge port 62 of the tip of the nozzle 61.

In the first embodiment, the discharge port 62 of the nozzle 61 has a bore diameter Dn. The bore diameter Dn of the nozzle 61 is a maximum value of the opening width of the discharge port 62 in a scanning direction of the nozzle 61. The “scanning direction of the nozzle 61” is a direction in which the position of the nozzle 61 moves relative to the forming table 210 while the nozzle 61 discharges the forming material. In a case in which the discharge port 62 has a circular shape, the bore diameter Dn corresponds to the diameter of the discharge port 62. In a case in which the discharge port 62 has a shape other than a circular shape, the bore diameter Dn corresponds to the distance between the end portions of the discharge port 62 which are at the most distanced positions in the scanning direction. In a case in which the discharge port 62 has a configuration in which a plurality of minute openings are arranged, the bore diameter Dn corresponds to the distance between the end portions on the outside in the two minute openings which are arranged closest to the outside in the scanning direction.

The opening-closing mechanism 70 opens and closes the flow path 65 to control the flowing out of the forming material from the nozzle 61. In the first embodiment, the opening-closing mechanism 70 is configured by a butterfly valve. The opening-closing mechanism 70 is provided with a drive shaft 72, a valve body 73, and a valve drive unit 74.

The drive shaft 72 is a shaft-shaped member which extends in one direction. The drive shaft 72 is attached to the exit of the flow path 65 to intersect the flow direction of the forming material. In the first embodiment, the drive shaft 72 is attached to be perpendicular to the flow path 65. FIG. 1 illustrates a configuration in which the drive shaft 72 is disposed parallel to the Y direction. The drive shaft is attached to be capable of rotating centered on a center axis of the drive shaft 72.

The valve body 73 is a plate-shaped member which rotates inside the flow path 65. In the first embodiment, the valve body 73 is formed by machining a part which is disposed inside the flow path 65 of the drive shaft 72 into a plate shape. The shape of the valve body 73, when viewed in a direction which is perpendicular to the plate surface, substantially matches the opening shape of the flow path 65 at the part at which the valve body 73 is disposed.

The valve drive unit 74 generates a rotational driving force which rotates the drive shaft 72 under the control of the control unit 101. The valve drive unit 74 is configured by a stepping motor, for example. The valve body 73 rotates inside the flow path 65 according to the rotation of the drive shaft 72.

As illustrated in FIG. 1, a state in which the plate surface of the valve body 73 runs parallel to the flow direction of the forming material in the flow path 65 is a state in which the flow path 65 is open. In this state, the flowing of the forming material from the flow path 65 into the nozzle 61 is allowed and the forming material flows out from the discharge port 62. A state in which the plate surface of the valve body 73 is perpendicular to the flow direction of the forming material in the flow path 65 is a state in which the flow path 65 is closed. In this state, the flowing of the forming material from the flow path 65 into the nozzle 61 is blocked and the flowing out of the forming material from the discharge port 62 is stopped.

The forming table 210 is disposed at a position facing the discharge port 62 of the nozzle 61. The forming table 210 includes a top surface 211 which is disposed to be parallel to the X and Y directions. As described later, in the forming apparatus 100, the forming material is deposited on the top surface 211 of the forming table 210 and a formed object is formed.

In the following explanation, a predetermined direction which is parallel to the top surface 211 of the forming table 210 is also referred to as “a first direction” and a direction which is perpendicular to the first direction is also referred to as “a second direction”. In the first embodiment, since the top surface 211 of the forming table 210 is disposed horizontally, the first direction is parallel with the horizontal direction and is parallel with the X direction and the Y direction. The second direction is parallel with the vertical direction and is parallel with the Z direction.

The movement mechanism 230 changes the relative positions of the forming table 210 and the nozzle 61. In the first embodiment, the movement mechanism 230 causes the forming table 210 to move relative to the nozzle 61. The movement mechanism 230 is configured by a three-axis positioner which causes the forming table 210 to move in the three axial directions of the X, Y, and Z directions using the driving force of three motors M. Under the control of the control unit 101, the movement mechanism 230 modifies the relative positional relationship between the nozzle 61 and the forming table 210.

In the forming apparatus 100, instead of a configuration in which the forming table 210 is moved by the movement mechanism 230, a configuration may be adopted in which the movement mechanism 230 causes the nozzle 61 to move with respect to the forming table 210 in a state in which the position of the forming table 210 is fixed. Even in this configuration, it is possible to modify the relative positional relationship between the nozzle 61 and the forming table 210. In the following description, the expression “the movement speed of the nozzle 61” means the speed of the nozzle 61 relative to the forming table 210. The expression “the movement distance of the nozzle 61” means the distance by which the nozzle 61 moves relative to the forming table 210.

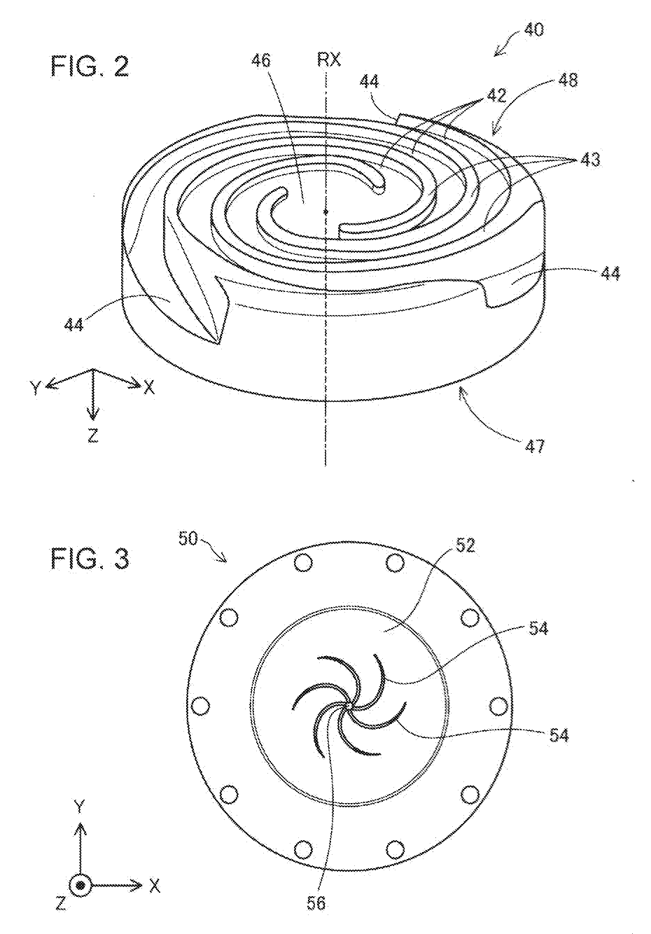

FIG. 2 is a schematic perspective view illustrating the configuration of the bottom surface 48 side of the flat screw 40. In FIG. 2, the position of the rotational axis RX of the flat screw 40 during the rotation in the forming material generating unit 30 is depicted using a dot-dash line. As explained with reference to FIG. 1, the groove portions 42 are provided in the bottom surface 48 of the flat screw 40 which faces the screw surface facing portion 50. Hereinafter, the bottom surface 48 will also be referred to as “the groove forming surface 48”.

The center portion 46 of the groove forming surface 48 of the flat screw 40 is configured as a recessed portion to which one end of each of the groove portions 42 is connected. The center portion 46 faces the communicating hole 56 of the screw surface facing portion 50 which is depicted in FIG. 1. In the first embodiment, the center portion 46 intersects the rotational axis RX.

The groove portions 42 of the flat screw 40 configure so-called scroll grooves. Each of the groove portions 42 extends in a spiral shape to draw an arc from the center portion 46 toward the outer circumference of the flat screw 40. The groove portions 42 may be configured to extend in a helical shape. Ridge portions 43 which configure side wall portions of the groove portions 42 and extend along each of the groove portions 42 are provided on the groove forming surface 48.

The groove portions 42 continue to a material inflow port 44 which is formed in the side surface of the flat screw 40. The material inflow port 44 is a portion which accepts the material which is supplied via the communicating path 22 of the material supply unit 20.

When the flat screw 40 rotates, at least a portion of the material which is supplied from the material inflow port 44 is melted while being heated inside the groove portions 42 and the fluidity increases. The material flows to the center portion 46 through the groove portions 42, gathers at the center portion 46, and is guided to the nozzle 61 and is discharged from the discharge port 62 by the internal pressure which is generated by the gathering.

FIG. 2 illustrates an example of the flat screw 40 which includes three of the groove portions 42 and three of the ridge portions 43. The number of the groove portions 42 and the ridge portions 43 which are provided on the flat screw 40 is not limited to three. Only one of the groove portions 42 may be provided on the flat screw 40, and a plurality greater than equal to two of the groove portions 42 may be provided on the flat screw 40. A predetermined number of the ridge portions 43 may be provided to match the number of the groove portions 42.

FIG. 2 illustrates an example of the flat screw 40 in which the material inflow port 44 is formed at three locations. The number of the material inflow ports 44 which are provided in the flat screw 40 is not limited to the three locations. The material inflow port 44 may be provided at only the one location in the flat screw 40, and may be provided at a plurality of greater than or equal to two locations.

FIG. 3 is a schematic plan view illustrating the top surface 52 side of the screw surface facing portion 50. As described above, the top surface 52 of the screw surface facing portion 50 faces the groove forming surface 48 of the flat screw 40. Hereinafter, the top surface 52 will also be referred to as “the screw facing surface 52”. The communicating hole 56 (described above) for supplying the forming material to the nozzle 61 is formed in the center of the screw facing surface 52.

A plurality of guide grooves 54 which are connected to the communicating hole 56 and extend in a spiral shape from the communicating hole 56 toward the outer circumference are formed in the screw facing surface 52. The plurality of guide grooves 54 has a function of guiding the forming material to the communicating hole 56. As explained with reference to FIG. 1, the heater 58 for heating the material is embedded in the screw surface facing portion 50. The melting of the material in the forming material generating unit 30 is realized through the heating by the heater 58 and the rotation of the flat screw 40.

Reference will be given to FIG. 1. By using the flat screw 40 which has a small size in the Z direction in the forming unit 110, the area occupied in the Z direction by the path for melting and guiding at least a portion of the material to the nozzle 61 is reduced. In this manner, by using the flat screw 40 in the forming apparatus 100, the generation mechanism of the forming material is reduced in size.

By using the flat screw 40 in the forming apparatus 100, the configuration which pumps the forming material in the fluid state to the nozzle 61 is easily realized. Accordingly, it is possible to control the speed of revolution of the flat screw 40 by controlling the discharge amount of the forming material from the nozzle 61 and the discharge control of the forming material from the nozzle 61 is simplified. The expression “the discharge amount of the forming material from the nozzle 61” means the flow rate of the forming material which flows out from the discharge port 62 of the nozzle 61.

In the forming apparatus 100, the forming material in which fluidity is realized is guided to the nozzle 61 through the flow path 65 due to the forming apparatus 100 including a generation mechanism of the forming material which uses the flat screw 40. Therefore, the discharge control of the forming material by the opening-closing mechanism 70 of a simple configuration which is provided downstream of the flow path 65 becomes possible.

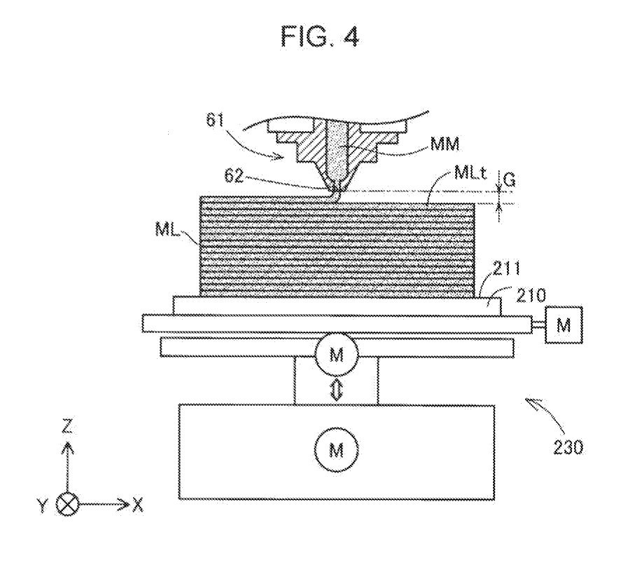

A description will be given of the forming by the discharging process which is executed by the forming apparatus 100 with reference to FIG. 4. FIG. 4 is a schematic diagram schematically illustrating a state of the forming apparatus 100 forming a formed object according to a discharging process. In the forming apparatus 100, the following discharging process is executed under the control of the control unit 101 when forming the formed object.

In the discharging process, as described above, in the forming material generating unit 30, at least a portion of the solid-state material which is supplied to the rotating flat screw 40 is melted and a forming material MM is generated. The forming material MM is discharged from the nozzle 61 toward the top surface 211 of the forming table 210 while changing the position of the nozzle 61 relative to the forming table 210 in the first direction which is parallel to the top surface 211 of the forming table 210 using the movement mechanism 230. In the discharging process, the forming material MM which is discharged from the nozzle 61 is continuously deposited in the first direction which is the scanning direction of the nozzle 61.

The control unit 101 causes the position of the nozzle 61 to move in the Z direction relative to the forming table 210 and forms the formed object by using the next discharging process to further stack the forming material MM on formed layers ML which are formed in the discharging processes to this point. Hereinafter, a layer which is configured by the forming material MM which is deposited by the discharging process when the nozzle 61 is at the same height with respect to the top surface 211 of the forming table 210 will also be referred to as “the formed layer ML”. In other words, in the forming apparatus 100, the formed object is formed by the stacking of the formed layers ML.

Incidentally, it is desirable that, when forming the formed layer ML, a gap G be maintained between the discharge port 62 of the tip of the nozzle 61 and a planned part MLt at which the forming material MM which is discharged from the nozzle 61 is to be deposited in the vicinity of a position directly under the nozzle 61. In a case in which the forming material MM is stacked on the formed layer ML, the planned part MLt at which the forming material MM is to be stacked is the top surface of the formed layer ML which is positioned under the nozzle 61.

It is desirable that the size of the gap G be greater than or equal to the bore diameter Dn (illustrated in FIG. 1) in the discharge port 62 of the nozzle 61, and it is more preferable that the size of the gap G be greater than or equal to 1.1 times the bore diameter Dn. Accordingly, the forming material MM which is discharged from the discharge port 62 of the nozzle 61 is stacked in a free state in which the forming material MM is not pushed into the planned part MLt. As a result, it is possible to suppress the crushing of the horizontal sectional shape of the forming material MM which is discharged from the nozzle 61, and it is possible to reduce the surface roughness of the formed object. In a configuration in which a heater is provided in the periphery of the nozzle 61, it is possible to prevent the overheating of the forming material MM by the heater by forming the gap G, and discoloration and degradation caused by the overheating of the forming material MM after the depositing are suppressed. Meanwhile, it is preferable that the size of the gap G be less than or equal to 1.5 times the bore diameter Dn, and it is particularly preferable that the size of the gap G be less than or equal to 1.3 times the bore diameter Dn. Accordingly, the positional deviation of the depositing position of the forming material MM with respect to the planned part MLt and a reduction in the close adherence properties between the formed layers ML are suppressed.

In a case in which the control unit 101 interrupts the discharging process to modify the position of the nozzle 61 relative to the forming table 210, the control unit 101 uses the valve body 73 of the opening-closing mechanism 70 to block the flow path 65 and stops the discharging of the forming material MM from the discharge port 62. After modifying the position of the nozzle 61, the control unit 101 restarts the deposition of the forming material MM from the position of the nozzle 61 after the modification by opening the flow path 65 using the valve body 73 of the opening-closing mechanism 70. According to the forming apparatus 100, it is possible to easily control the depositing position of the forming material MM by the nozzle 61 due to the forming apparatus 100 including the opening-closing mechanism 70.

A description will be given of the material which is used in the forming apparatus 100. In the forming apparatus 100, it is possible to form the formed object using various materials such as a material having plasticity, a metal material, or a ceramic material, for example, as a main material. Here, “the main material” means a material which is central to forming the shape of the formed object and means a material which occupies a content of greater than or equal to 50 wt % in the formed object. The forming material MM which is described above includes a forming material in which the main materials described above are melted in isolation, and a forming material in which a component which is a portion contained together with the main material is melted and rendered paste form.

In a case in which a thermoplastic material is used as the main material, the forming material MM is generated by the material being plasticized in the forming material generating unit 30. The term “plasticize” means a heat is applied to the thermoplastic material and the material is melted.

It is possible to use a thermoplastic resin material, for example, as the thermoplastic material.

### Examples of Thermoplastic Resin Material

General purpose engineering plastics such as polypropylene resin (PP), polyethylene resin (PE), polyacetal resin (POM), polyvinyl chloride resin (PVC), polyamide resin (PA), acrylonitrile-butadiene-styrene resin (ABS), polylactic acid resin (PLA), polyphenylene sulfide resin (PPS), polyether ether ketone (PEEK), polycarbonate (PC), modified polyphenylene ether, polybutylene terephthalate, and polyethylene terephthalate. Engineering plastics such as polysulfone, polyethersulfone, polyphenylene sulfide, polyarylate, polyimide, polyamide imide, polyether imide, and polyether ether ketone.

In addition to pigments, metals, and ceramics, additives such as wax, flame retardant, antioxidant, thermal stabilizer may be mixed into the thermoplastic material. The thermoplastic material is plasticized by the rotation of the flat screw 40 and the heating of the heater 58 in the forming material generating unit 30 and is transformed to a melted state. The forming material MM which is generated in this manner is discharged from the nozzle 61 and is subsequently cured by a reduction in temperature.

It is desirable that the thermoplastic material be heated to a glass transition point or greater and be ejected from the nozzle 61 in a completely melted state. For example, the glass transition point of ABS resin is approximately 120° C. and it is desirable that the ABS resin be approximately 200° C. at the time of ejection from the nozzle 61. A heater may be provided in the periphery of the nozzle 61 in order to eject the forming material MM in such a high-temperature state.

In the forming apparatus 100, the following metal materials may be used as the main material, for example, instead of the thermoplastic material which is described above. In this case, it is desirable that a component which melts during the generation of the forming material MM be mixed into a powder material obtained by rendering the following metal materials into a powder form and the result be inserted into the forming material generating unit 30.

### Examples of Metal Material

A single metal or an alloy containing more than one metal from among magnesium (Mg), iron (Fe), cobalt (Co), chrome (Cr), aluminum (Al), titanium (Ti), copper (Cu), and nickel (Ni).

### Examples of Alloy

Maraging steel, stainless steel, cobalt chromium molybdenum, titanium alloy, nickel alloy, aluminum alloy, cobalt alloy, and cobalt chromium alloy.

It is possible to use a ceramic material as the main material instead of the metal material in the forming apparatus 100. For example, it is possible to use oxide ceramics such as silicon dioxide, titanium dioxide, aluminum oxide, and zirconium oxide, and non-oxide ceramics such as aluminum nitride as the ceramic material. In a case in which a metal material or a ceramic material such as those described above is used as the main material, the forming material MM which is disposed on the forming table 210 may be cured by sintering.

The powder material of the metal material or the ceramic material which is inserted into the material supply unit 20 may be a mixed material in which a plurality of types of powders of a single metal, powders of alloys, and powders of ceramic material are mixed together. The powder material of the metal material or the ceramic material may be coated with a thermoplastic resin such as those exemplified above, or alternatively, a different thermoplastic resin, for example. In this case, in the forming material generating unit 30, the fluidity may be realized by melting the thermoplastic resin.

It is possible to add the following solvents, for example, to the powder material of the metal material or the ceramic material which is inserted into the material supply unit 20. It is possible to use one species or two or more species in combination in combination as the solvent.

### Examples of Solvent

Water; (poly) alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl n-butyl ketone, diisopropyl ketone, and acetyl acetone; alcohols such as ethanol, propanol, and butanol; tetraalkyl ammonium acetates; sulfoxide solvents such as dimethyl sulfoxide, and diethyl sulfoxide; pyridine-based solvents such as picoline, γ-picoline, and 2,6-lutidine; tetraalkyl ammonium acetate (for example, tetrabutyl ammonium acetate or the like); and ionic liquids such as butyl carbitol acetate.

It is possible to add the following binders, for example, to the powder material of the metal material or the ceramic material which is inserted into the material supply unit 20.

### Examples of Binder

Acrylic resin, epoxy resin, silicone resin, cellulose resin, or alternatively, another synthetic resin or polylactic acid (PLA), polyamide (PA), polyphenylene sulfide (PPS), polyether ether ketone (PEEK), or alternatively, another thermoplastic resin.

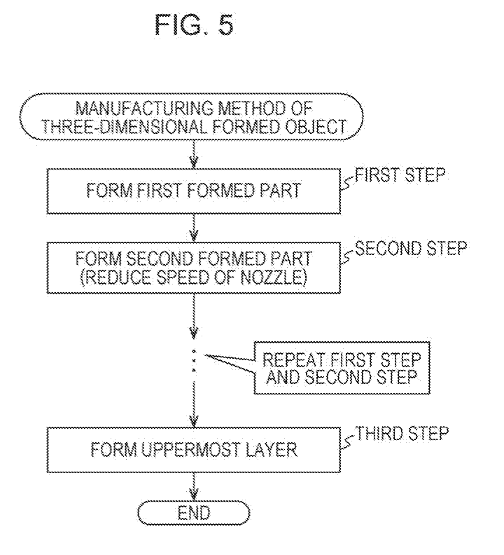

FIG. 5 is an explanatory diagram illustrating a flow of forming steps of a manufacturing method of a formed object in the first embodiment. The control unit 101 causes the forming apparatus 100 to execute a first step to a third step which are described hereinafter to swiftly form a formed object with high forming precision.

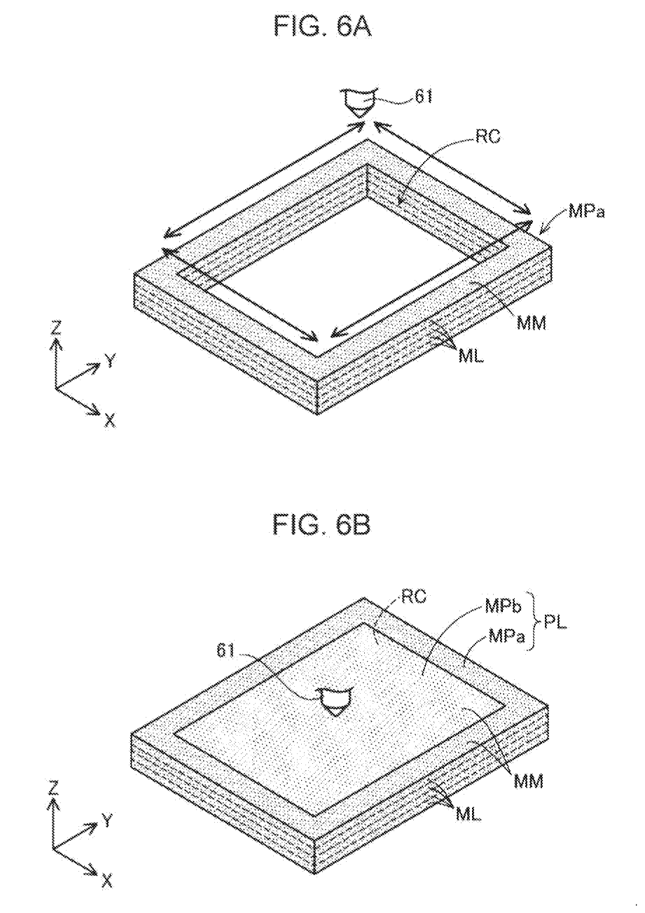

A description will be given of the first step with reference to FIG. 6A. FIG. 6A is a schematic diagram illustrating an example of a first formed part MPa which is formed in the first step. In the first step, the control unit 101 uses the discharging process which is described with reference to FIG. 4 to cause the forming material MM to be deposited on the forming table 210 and forms the first formed part MPa. The first formed part MPa includes a recessed portion RC which is open in the second direction which is a direction heading from the forming table 210 toward the nozzle 61.

The first formed part MPa is a part which configures an outer shell of the formed object. The control unit 101 executes the discharging process to form the first formed part MPa according to forming data for forming the formed object. As illustrated by the solid arrow, the control unit 101 causes the forming material MM to be discharged from the nozzle 61 while causing the nozzle 61 to move relative to the forming table 210 along an outer circumferential contour shape of a cross-section of the formed object cut along the first direction to form the first formed part MPa. The first formed part MPa is formed by stacking one or more of the formed layers ML.

The shape of the recessed portion RC is not particularly limited. The recessed portion RC may be configured by a through-hole which penetrates the first formed part MPa in the Z direction, or alternatively, the recessed portion RC may be configured as a bottomed depressed portion which includes a base portion which is configured by the forming material MM. In a case in which the first formed part MPa configures the bottommost layer of the formed object, the bottom surface of the base portion of the recessed portion RC configures the base surface of the formed object. A plurality of the recessed portions RC may be formed in the first formed part MPa. The forming position and the shape of the recessed portion RC is determined in advance before the control unit 101 executes the first step based on the forming data.

As described above, since the first formed part MPa is a part which configures the outer shell of the formed object, it is desirable that the first formed part MPa be formed to include a fine-detailed structure. Therefore, in a case in which wall-shaped parts are formed by arranging rows of the forming material MM which are formed by the scanning of the nozzle 61 in the first direction in the discharging process of the first step, it is desirable that the interval of the scanning path of the nozzle 61 be rendered narrower such that adjacent rows more tightly contact each other.

It is desirable that the first formed part MPa be formed finely at a high forming precision. Therefore, in the discharging process of the first step, for example, when the control unit 101 modifies the scanning direction of the nozzle 61 at an acute angle greater than or equal to 45°, the control unit 101 may execute control in which the discharge amount of the forming material MM from the nozzle 61 is reduced. According to the control, it is possible to suppress an increase in the deposition amount of the forming material MM which is greater than a designed value accompanying a decrease in the movement speed of the nozzle 61 when changing the movement direction of the nozzle 61 at an acute angle.

A description will be given of the second step with reference to FIGS. 6B, 7A to 7C, and 8. FIG. 6B is a diagram schematically illustrating an example of a second formed part MPb which is formed in the second step. In FIG. 6B, for convenience, the second formed part MPb is given a different density of hatching from the first formed part MPa.

In the second step, the control unit 101 uses the discharging process to cause the forming material MM to be deposited inside the recessed portion RC of the first formed part MPa and forms the second formed part MPb. The second formed part MPb is embedded in the inner portion of the formed object. The second formed part MPb is formed to be in contact with the inner wall surface of the recessed portion RC of the first formed part MPa and to be fixed to the inside of the recessed portion RC. The second formed part MPb is formed by stacking one or more of the formed layers ML to have the same height as the first formed part MPa. Hereinafter, a layer which is obtained by forming the second formed part MPb in the recessed portion RC of the first formed part MPa is also referred to as “a partial layer PL”.

In the second step, the forming material MM is deposited to fill the inside of the recessed portion RC using the discharging process. However, the forming material MM may not be deposited in such fine detail as to completely fill the inner portion space of the recessed portion RC without gaps. The second formed part MPb may be formed such that minute gap spaces are suitably formed in the inner portion of the second formed part MPb, and the second formed part MPb may be formed using a structure having a lower density than that of the first formed part MPa. It is possible to form the gap spaces by enlarging the interval between the paths which are scanned by the nozzle 61 to provide gaps between the forming material MM which is deposited adjacently in the first direction. In order to increase the forming precision of a part which is formed on the second formed part MPb or to increase the strength of the formed object, it is desirable that the gap space in the inner portion of the second formed part MPb be as small as possible and it is desirable that the gap spaces be more sparsely distributed. It is desirable that the gap spaces be uniformly distributed in three dimensions.

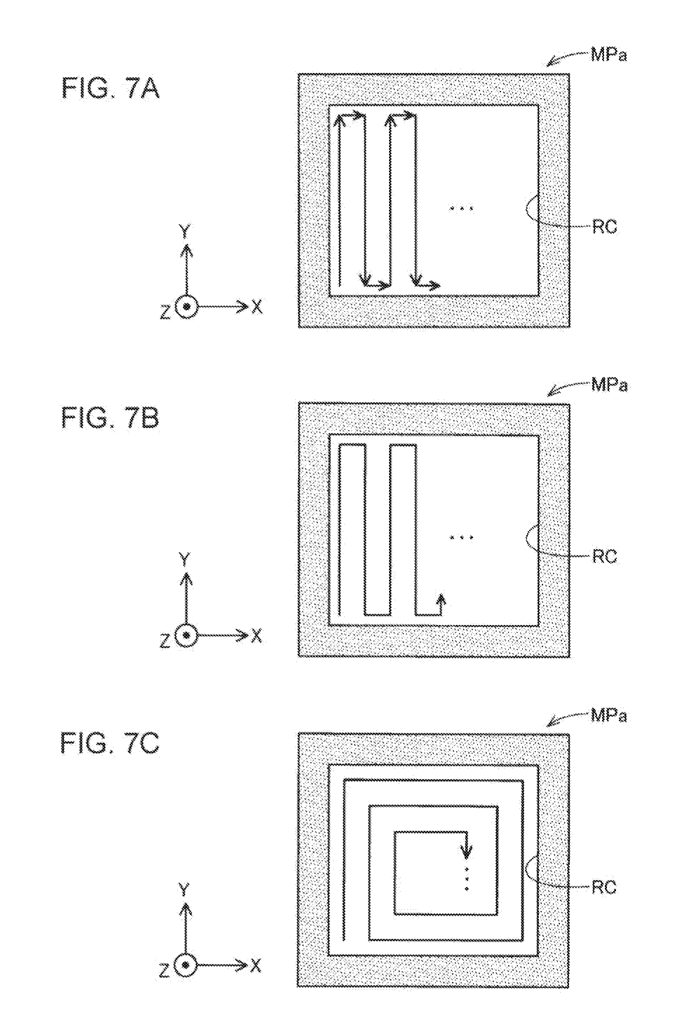

Each of FIGS. 7A to 7C schematically illustrates an example of a movement pattern of the nozzle 61 when forming the second formed part MPb in the second step.

In the first example of FIG. 7A, a linear movement in the Y direction of the nozzle 61 in the space from one end portion to another end portion of the recessed portion RC while discharging the forming material MM and a movement in which the position of the nozzle 61 is offset in the X direction in a state in which the discharging of the forming material MM is stopped are repeated alternately. In FIG. 7A, the movement path of the nozzle 61 while discharging the forming material MM is indicated by the solid arrow and the movement path of the nozzle 61 in a state in which the discharging of the forming material MM is stopped is illustrated by a dashed arrow. According to the movement pattern of the nozzle 61 of the first example, the formed layer ML, in which a plurality of rows in which the forming material MM is deposited linearly in one direction are arranged, is formed inside the recessed portion RC.

In the second example of FIG. 7B, the control unit 101 causes the nozzle 61 to meander above the recessed portion RC without stopping the discharging of the forming material MM. More specifically, the control unit 101 repeats a linear reciprocal movement of the nozzle 61 along the Y direction from one end portion to another end portion of the recessed portion RC while causing the position of the nozzle 61 to deviate in the X direction. According to the movement pattern of the nozzle 61 of the second example, the formed layer ML, in which a plurality of rows in which the forming material MM is deposited linearly in one direction are arranged along the first direction in a state of being connected in a hairpin fashion, is formed inside the recessed portion RC.

In the third example of FIG. 7C, the control unit 101 causes the nozzle 61 to rotationally scan in a spiral pattern above the recessed portion RC without stopping the discharging of the forming material MM. More specifically, the control unit 101 causes the forming material MM to be discharged from the nozzle 61 while causing the nozzle 61 to revolve so as to form a spiral shape along the inner wall surface of the recessed portion RC heading from the outside toward the inside with respect to the first formed part MPa. According to the movement pattern of the nozzle 61 of the third example, the formed layer ML, in which a row of the forming material MM is arranged in a spiral shape along the first direction, is formed inside the recessed portion RC.

The movement pattern of the nozzle 61 in the discharging process of the second step is not limited to the three examples given above. For example, the three movement patterns may be combined to form the second formed part MPb.

In the second step, the control unit 101 forms the second formed part MPb in a shorter forming time per unit volume than the forming time per unit volume of the first formed part MPa in the first step. The expression “the forming time per unit volume of the first formed part MPa” means a value obtained by dividing the volume of a part excluding the recessed portion RC of the first formed part MPa by the forming time taken to form the first formed part MPa in the first step. In other words, this corresponds to an average forming time in which the forming time taken for a part of the first formed part MPa is made uniform over the entirety of the first formed part MPa. In comparison, the expression “the forming time per unit volume of the second formed part MPb” means a value obtained by dividing the volume of the space inside the recessed portion RC which is buried by the second formed part MPb by the forming time taken to form the second formed part MPb in the second step. In other words, the forming time for a part of the recessed portion RC which is taken to fill the recessed portion RC corresponds to an average forming time made uniform over the entirety of the recessed portion RC.

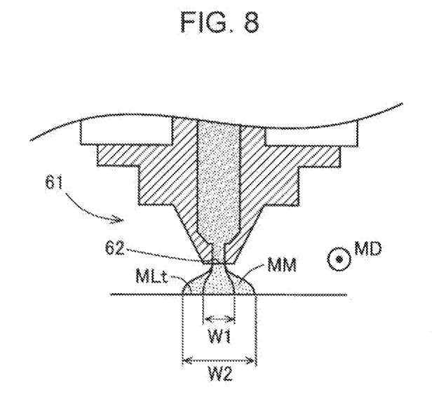

A description will be given of a method of shortening the forming time per unit volume of the second formed part MPb to be shorter than the forming time per unit volume of the first formed part MPa, with reference to FIG. 8. FIG. 8 schematically illustrates a state of the forming material MM when the forming material MM is discharged from the nozzle 61 onto the planned part MLt in the second step. In FIG. 8, a scanning direction MD of the nozzle 61 which is perpendicular to the paper surface of FIG. 8 is depicted using a dot which means an arrow which is perpendicular to the paper surface.

In the second step of the first embodiment, the control unit 101 lowers the movement speed of the nozzle 61 with respect to the forming table 210 in the discharging process as compared to during the first step to increase the area of the forming material MM which is deposited under the nozzle 61 to a larger area than in the first step. In the second step, the movement speed of the nozzle 61 is lowered to approximately 50%, for example, of the movement speed during the first step.

When the movement speed of the nozzle 61 is lowered while keeping the discharge amount of the forming material MM from the nozzle 61 unchanged, it is possible to increase the amount of the forming material MM which is deposited under the nozzle 61. Therefore, the width over which the forming material MM is deposited on the planned part MLt under the nozzle 61 is widened from W1 during the first step to W2 due to the flowing of the forming material MM. Here, “width” means the dimension of the deposition area of the forming material MM in a direction which orthogonally intersects the scanning direction MD of the nozzle 61.

Even if the movement speed of the nozzle 61 is lowered, as long as the area of the forming material MM which is deposited under the nozzle 61 increases, the proportion of the area on which the forming material MM is deposited to the movement distance of the nozzle 61 in the discharging process increases. Therefore, it is possible to reduce the sum of the movement distance of the nozzle 61 for filling the recessed portion RC in the second step. If the width of the forming material MM which is deposited under the nozzle 61 in the discharging process is expanded, it is possible to increase the interval at which the gap spaces which are present in the inner portion of the second formed part MPb are distributed by an amount corresponding to the amount by which the width is expanded. Accordingly, according to the discharge control in the second step in the first embodiment, it is possible to shorten the forming time per unit volume of the second formed part MPb while increasing the density of the second formed part MPb.

Reference will be given to FIG. 5. The control unit 101 repeats the first step and the second step which are described above to stack the partial layers PL which are configured by the first formed part MPa and the second formed part MPb such as exemplified in FIG. 6B in the Z direction. In the third step, the control unit 101 forms the uppermost layer of the formed object to cover the exposed top surface of the second formed part MPb and completes the forming step. In a case in which the partial layer PL forms a formed object of only one layer, only the third step may be executed without the first step and the second step being repeated. For example, if the second formed part MPb may be exposed to the outside, the third step may be omitted.

As described above, according to the manufacturing method of the formed object and the forming apparatus 100 of the first embodiment, it is possible to easily generate the forming material MM which has fluidity in a miniature apparatus configuration by using the flat screw 40. It is possible to precisely control the discharging of the forming material MM from the nozzle 61. Accordingly, even in a case in which the material which is prepared in a solid state is used, it is possible to swiftly form the formed object at high precision using simpler steps and configurations. Since the forming time of the second formed part MPb, for which high forming precision is not demanded in comparison to the first formed part MPa which configures the outer shell of the formed object, is shortened, it is possible to shorten the forming time while suppressing a reduction in the forming precision of the formed object. In particular, according to the configuration of the first embodiment, it is possible to shorten the forming time per unit volume of the second formed part MPb while increasing the density of the second formed part MPb using a simple control which lowers the movement speed of the nozzle 61 when forming the second formed part MPb. Additionally, according to the manufacturing method of the formed object and the forming apparatus 100 of the first embodiment, it is possible to realize the various operations and effects which are described in the first embodiment.

### 2. Second Embodiment

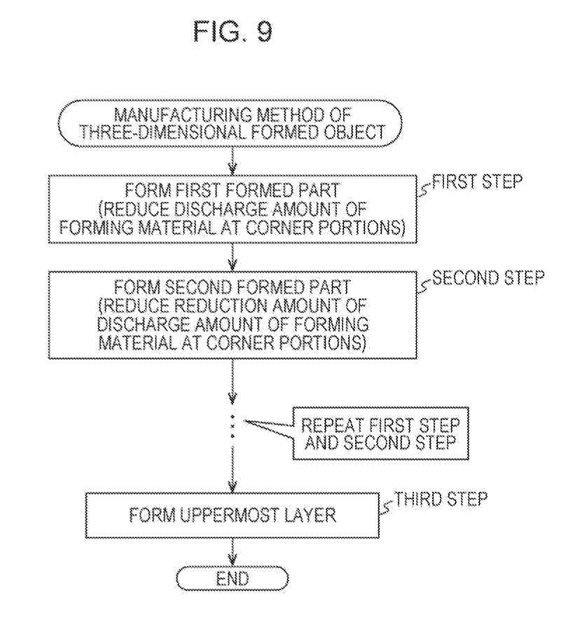

FIG. 9 is an explanatory diagram illustrating the flow of the forming steps of the manufacturing method of the formed object in the second embodiment. The flow of the forming steps in the second embodiment is substantially the same as the flow described in the first embodiment with reference to FIG. 5 except in the following points. The configuration of the forming apparatus of the second embodiment is substantially the same as the configuration of the forming apparatus 100 of the first embodiment illustrated in FIGS. 1 to 3 except in that the control unit 101 executes the flow of the forming steps.

In the discharging process of the first step, the control unit 101 executes control in which the discharge amount of the forming material MM from the nozzle 61 is reduced when modifying the movement direction of the nozzle 61 by an acute angle in order to form a corner portion of the first formed part MPa. The control unit 101 executes the control when modifying the movement direction of the nozzle 61 by an acute angle of greater than or equal to 45°, for example. The movement speed of the nozzle 61 is temporarily reduced when modifying the movement direction of the nozzle 61 by an acute angle. At this time, if the discharge amount of the forming material MM from the nozzle 61 is reduced, it is possible to suppress an increase in the deposition amount of the forming material MM which is greater than a designed value accompanying the reduction in the movement speed of the nozzle 61. Accordingly, it is possible to increase the forming precision of the first formed part MPa as compared to a case in which the control is not performed.

In the discharging process of the second step, the control unit 101 does not allow the discharge amount of the forming material MM from the nozzle 61 to become lower than during the first step when modifying the movement direction of the nozzle 61 by the acute angle. In other words, the lowering amount of the discharge amount of the forming material MM from the nozzle 61 is reduced as compared to during the first step. In the second embodiment, the discharge amount of the forming material MM from the nozzle is barely reduced. Accordingly, it is possible to shorten the time necessary for lowering the discharge amount of the forming material MM from the nozzle 61 and it is possible to shorten the forming time per unit volume of the second formed part MPb. In the discharging process of the second step, the movement speed of the nozzle 61 may be lowered by a shorter time than during the first step when modifying the movement direction of the nozzle 61 by an acute angle. Accordingly, it is possible to further shorten the forming time per unit volume of the second formed part MPb.

According to the manufacturing method of the formed object and the forming apparatus of the second embodiment, it is possible to shorten the forming time per unit volume of the second formed part MPb using simple control of the movement speed of the nozzle 61 and the discharge amount of the forming material MM. Additionally, according to the manufacturing method and the forming apparatus of the second embodiment, in addition to the various operations and effects which are described in the second embodiment, it is possible to realize various operations and effects which are similar to those described in the first embodiment.

### 3. Third Embodiment

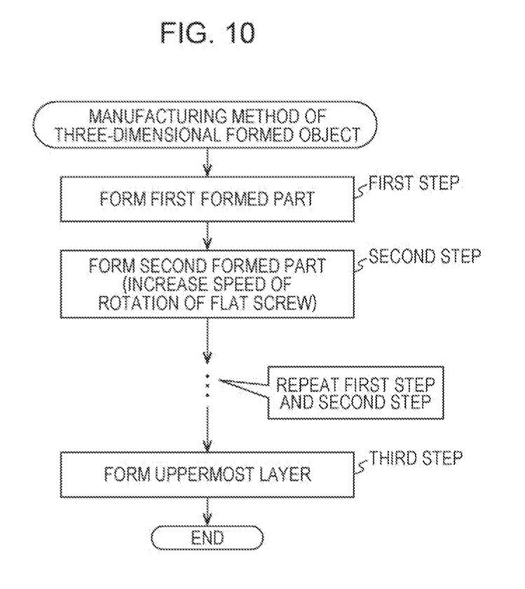

FIG. 10 is an explanatory diagram illustrating the flow of the forming steps of the manufacturing method of the formed object in the third embodiment. The flow of the forming steps in the third embodiment is substantially the same as the flow described in the first embodiment with reference to FIG. 5 except in that the control content of the discharging process in the second step differs as described hereinafter. The configuration of the forming apparatus of the third embodiment is substantially the same as the configuration of the forming apparatus 100 of the first embodiment illustrated in FIGS. 1 to 3 except in that the control unit 101 executes the flow of the forming steps.

In the discharging process of the second step, the control unit 101 further increases the speed of revolution of the flat screw 40 as compared to during the first step to increase the discharge amount of the forming material MM from the nozzle 61. Accordingly, it is possible to increase the area on which it is possible to deposit the forming material MM using scanning of the nozzle 61. Therefore, it is possible to reduce the sum of the movement distance of the nozzle 61 in the second step and it is possible to shorten the forming time per unit volume of the second formed part MPb. In the discharging process of the second step, the control unit 101 may further increase the movement speed of the nozzle 61 as compared to during the first step in addition to increasing the speed of revolution of the flat screw 40 as compared to during the first step.

According to the manufacturing method of the formed object and the forming apparatus of the third embodiment, it is possible to shorten the forming time per unit volume of the second formed part MPb using simple control of the speed of revolution of the flat screw 40. Additionally, according to the manufacturing method and the forming apparatus of the third embodiment, in addition to the various operations and effects which are described in the third embodiment, it is possible to realize various operations and effects which are similar to those described in the first embodiment.

### 4. Fourth Embodiment

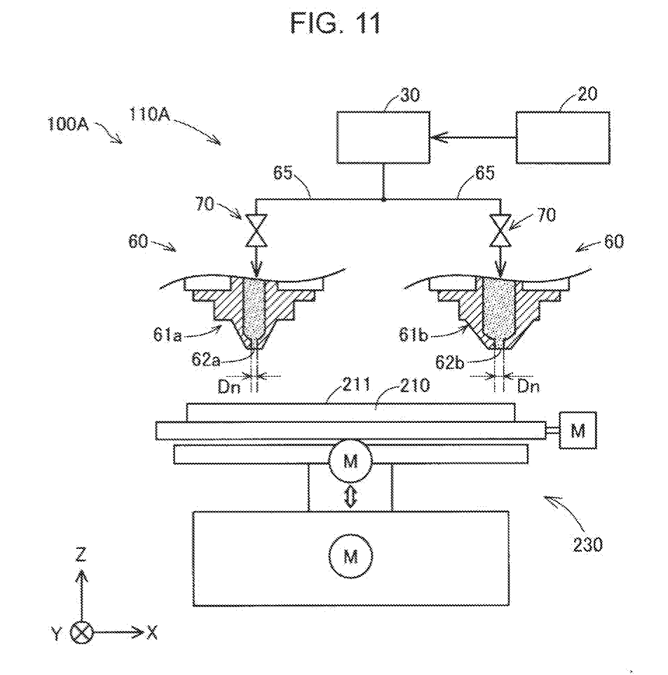

FIG. 11 is a schematic diagram illustrating the configuration of a forming apparatus 100A of the fourth embodiment. The configuration of the forming apparatus 100A of the fourth embodiment is substantially the same as the configuration of the forming apparatus 100 of the first embodiment except in that a forming unit 110A is provided with two of the discharging units 60.

In the forming unit 110A, the two discharging units 60 are provided with a first nozzle 61a or a second nozzle 61b, respectively. The first nozzle 61a and the second nozzle 61b are connected in parallel to the communicating hole 56 of the forming material generating unit 30 via the respective flow paths 65. The bore diameter Dn of a discharge port 62b of the second nozzle 61b is larger than the bore diameter Dn of a discharge port 62a of the first nozzle 61a. Each of the two discharging units 60 includes an opening-closing mechanism 70 corresponding to the first nozzle 61a and the second nozzle 61b. The control unit 101 executes the discharging process which causes the forming material MM to be discharged from one of the two nozzles 61a and 61b in the forming steps which is described hereinafter.

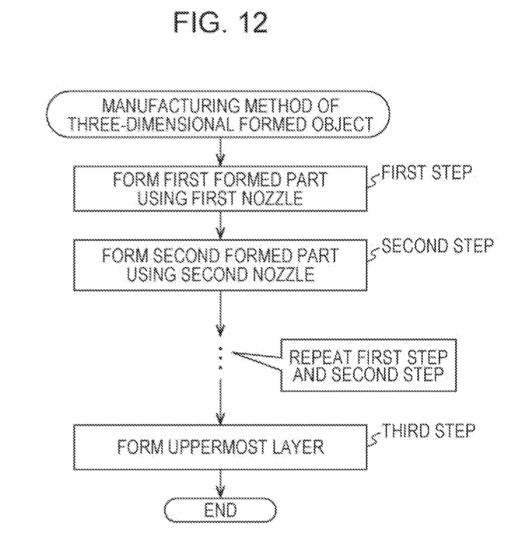

FIG. 12 is an explanatory diagram illustrating the flow of the forming steps of the manufacturing method of the formed object in the fourth embodiment. The flow of the forming steps of the fourth embodiment is the same as the flow described in the first embodiment except in that the content of the first step and the second step is different. In the forming steps of the fourth embodiment, in the first step and the second step, the nozzles 61a and 61b which are used in the discharging process are exchanged and the first formed part MPa and the second formed part MPb are formed.

The control unit 101 uses the first nozzle 61a to form the first formed part MPa in the discharging process of the first step. The control unit 101 uses the second nozzle 61b to form the second formed part MPb in the discharging process of the second step. Since the bore diameter Dn of the discharge port 62b of the second nozzle 61b is larger than the bore diameter Dn of the discharge port 62a of the first nozzle 61a, the width of the forming material MM which is deposited under the nozzle 61b during the scanning becomes larger than in the nozzle 61a. Accordingly, it is possible to render the forming time per unit volume of the second formed part MPb shorter than the forming time per unit volume of the first formed part MPa using the discharging process which uses the second nozzle 61b.

According to the manufacturing method of the formed object and the forming apparatus 100A of the fourth embodiment, it is possible to easily shorten the forming time per unit volume of the second formed part MPb by exchanging the first nozzle 61a for the second nozzle 61b which has a larger bore diameter Dn during the forming of the second formed part MPb. Additionally, according to the manufacturing method and the forming apparatus 100A of the fourth embodiment, it is possible to realize the same various operations and effects as those which are described in the first embodiment.

### 5. Fifth Embodiment

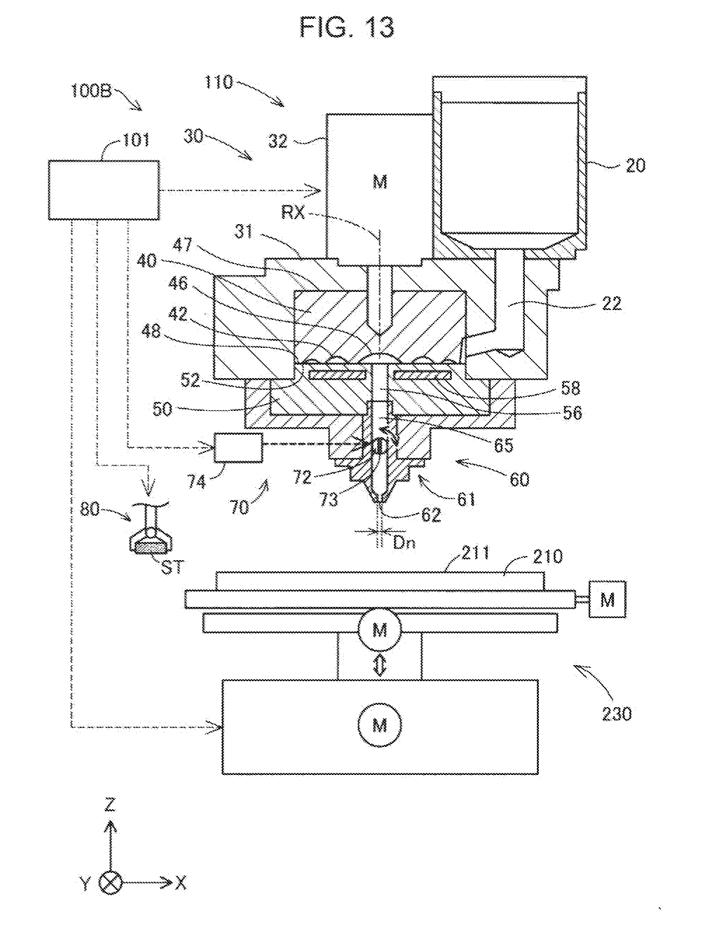

FIG. 13 is a schematic diagram illustrating the configuration of a forming apparatus 100B of the fifth embodiment. The configuration of the forming apparatus 100B of the fifth embodiment is substantially the same as the configuration of the forming apparatus 100 of the first embodiment except in that the forming apparatus 100B is provided with a transporting unit 80. The transporting unit is configured by a robot arm, for example. The transporting unit 80 transports a structure ST which is prepared in advance and is used in the second step of the forming steps described hereinafter and disposes the structure ST on the forming table 210 under the control of the control unit 101.

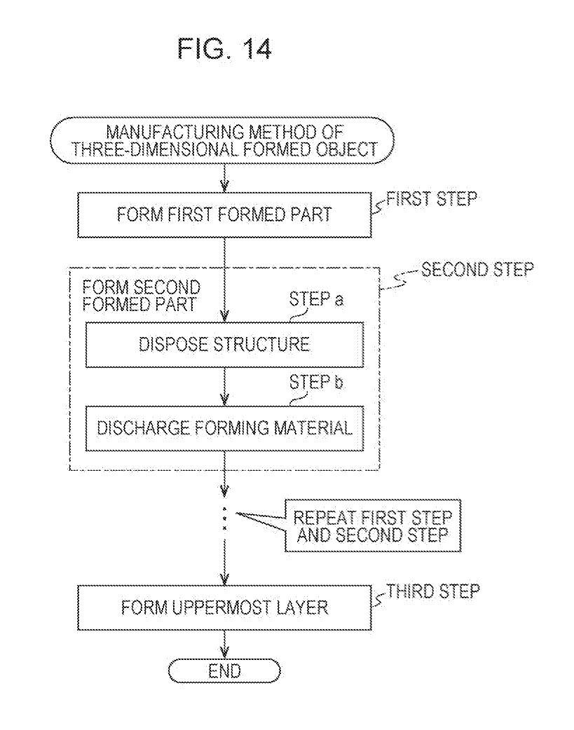

FIG. 14 is an explanatory diagram illustrating the flow of the forming steps of the manufacturing method of the formed object in the fifth embodiment. The forming steps of the fifth embodiment are substantially the same as the forming steps described in the first embodiment except in that the second step includes steps a and b. As described in the first embodiment, in the first step, the control unit 101 forms the first formed part MPa which includes the recessed portion RC using the discharging process.

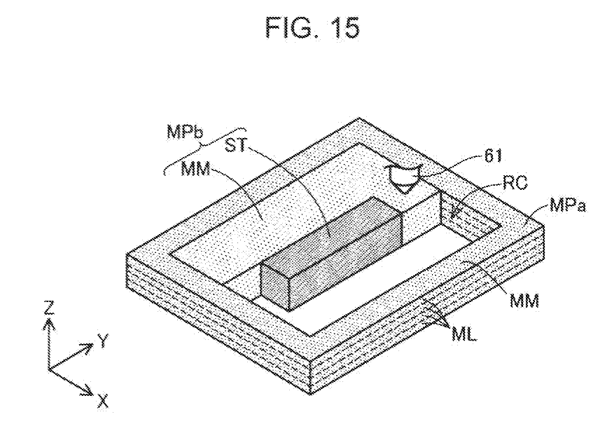

FIG. 15 is a schematic diagram for describing a second step of forming the second formed part MPb. In step a of the second step, the control unit 101 first controls the transporting unit 80 to dispose the structure ST inside the recessed portion RC of the first formed part MPa. The structure ST is configured in advance such that the entirety of the structure ST fits inside the recessed portion RC. The structure ST may be formed using the forming material MM in advance using the discharging process of the forming apparatus 100B, or alternatively, the structure ST may be manufactured by a different apparatus from the forming apparatus 100B using a different material from the forming material MM. The shape of the structure ST is not particularly limited. It is desirable that the volume of the structure ST, and the transport speed and the transport distance of the transporting unit 80 be adjusted such that the time necessary for disposing the structure ST using the transporting unit 80 is shorter than the time necessary for forming the formed object of a volume corresponding to the structure ST using the discharging process.

In step b of the second step, the control unit 101 uses the discharging process to cause the forming material MM to be deposited to fill the recessed portion RC and forms the second formed part MPb in a space inside the recessed portion RC in which the structure ST is not disposed. The structure ST configures a portion of the second formed part MPb.

If the second step of the fifth embodiment is adopted, since the space in which the forming material MM is deposited by the discharging process is reduced due to the structure ST being disposed inside the recessed portion RC in advance, the forming time per unit volume of the second formed part MPb is shortened. Here, the expression “the forming time per unit volume of the second formed part MPb” means dividing the volume of the space inside the recessed portion RC which is filled by the second formed part MPb containing the structure ST in a portion of the second formed part MPb by the time which is necessary for the second step including the step a of disposing the structure ST.

According to the manufacturing method of the formed object and the forming apparatus 100B of the fifth embodiment, it is possible to easily shorten the forming time per unit volume of the second formed part MPb by using the structure ST which is prepared in advance. Additionally, according to the manufacturing method of the formed object and the forming apparatus 100B of the fifth embodiment, it is possible to realize the same various operations and effects as those which are described in the first embodiment.

### 6. Other Embodiments

It is possible to modify the various configurations which are described in the embodiment in the manners described hereinafter, for example. All of the other embodiments which are described hereinafter are posited as examples for embodying the invention in the same manner as the embodiment which is described above.

### 6-1. First Other Embodiment

The method of shortening the forming time per unit volume of the second formed part MPb is not limited to the methods described in the above embodiments. For example, the forming time per unit volume of the second formed part MPb may be shortened by combining the methods which are described in the above embodiments. For example, at least two of the control of lowering the movement speed of the nozzle 61 in the first embodiment, the control of reducing the lowering amount of the discharge amount of the forming material MM when modifying the movement direction of the nozzle 61 in the second embodiment, the control of increasing the speed of revolution of the flat screw 40 in the third embodiment, and the control of exchanging the first nozzle 61a for the second nozzle 61b and using the second nozzle 61b in the fourth embodiment may be combined and executed. In the discharge control in step b of the second step of the fifth embodiment, at least one of the controls described in the first to the fourth embodiments may be executed.

### 6-2. Second Other Embodiment

The opening-closing mechanism 70 of the forming apparatus 100, 100A, or 100B may be configured such that a piston protrudes into the flow path 65 and a plunger blocks the flow path 65, or alternatively, may be configured using a shutter which moves in a direction intersecting the flow path 65 to block the flow path 65. The opening-closing mechanism 70 may be configured by combining at least two of the butterfly valve of the above embodiments, the shutter mechanism, and the plunger mechanism. In the forming apparatus 100, 100A, or 100B, the opening-closing mechanism 70 may be omitted.

### 6-3. Third Other Embodiment

In the fifth embodiment, the first nozzle 61a and the second nozzle 61b receive a supply of and discharge the same type of forming material MM from the shared forming material generating unit 30. In comparison, in the fifth embodiment, the first nozzle 61a and the second nozzle 61b are connected to separate forming material generating units 30 and may receive a supply of and discharge different types of the forming material MM.

### 6-4. Fourth Other Embodiment

In the above embodiments, the material supply unit 20 may include a configuration which includes a plurality of hoppers. In this case, a different material may be supplied from each hopper to the flat screw 40 and be mixed inside the groove portions 42 of the flat screw 40 to generate the forming material. For example, a powder material which serves as the main material which is described in the embodiment and solvents, binders, and the like which are added to the powder material may be supplied to the flat screw 40 from separate hoppers in parallel.

### 6-5. Fifth Other Embodiment

In the embodiment, a portion or all of the functions and processes which are realized using software may be realized using hardware. A portion or all of the functions and processes which are realized using hardware may be realized using software. It is possible to use various circuits such as integrated circuits, discrete circuits, or circuit modules which combine such circuits, for example, as the hardware.

### 7. Other Aspects

The invention is not limited to the embodiments and application examples which are described above and it is possible to realize the invention with various aspects in a scope that does not depart from the gist of the invention. For example, it is possible to realize the invention as the following aspects. Hereinafter, in order to solve a portion or all of the problems of the invention, or alternatively, in order to achieve a portion or all of the effects of the invention, it is possible to replace or combine, as appropriate, the technical features in the embodiments corresponding to technical features in the aspects which are described hereinafter. As long as a technical feature is not described as required in the specification, it is possible to remove the technical feature, as appropriate.

(1) The first aspect is provided as a manufacturing method of a three-dimensional formed object. The manufacturing method of the aspect includes a first step of causing a forming material to be deposited on a forming table to form a first formed part including a recessed portion which is open in a direction heading from the forming table toward a nozzle through a discharging process of supplying a material to a rotating flat screw to generate the forming material in which at least a portion of the material is melted and discharging the forming material from the nozzle toward the forming table while changing a relative position between the forming table and the nozzle, and a second step, including a step of causing the forming material to be deposited inside the recessed portion through the discharging process, of forming a second formed part which is fixed to the inside of the recessed portion in a shorter forming time per unit volume than a forming time per unit volume of the first formed part.

According to the manufacturing method of the aspect, it is possible to control the discharging of the forming material at high precision while easily generating the fluid forming material with a miniature apparatus configuration by using the flat screw. Accordingly, even in a case in which the material which is prepared in a solid state is used, it is possible to swiftly form the three-dimensional formed object at high precision using simpler steps and configurations. Since it is possible to shorten the forming time of the second formed part which configures the structure of the inner portion of the three-dimensional formed object and for which a higher forming precision than the first formed part is not demanded, it is possible to swiftly form the three-dimensional formed object.

(2) In the manufacturing method of the aspect, in the second step, an area on which the forming material is deposited under the nozzle may be rendered larger than in the first step by rendering a movement speed of the nozzle with respect to the forming table in the discharging process lower than that in the first step.

According to the manufacturing method of the aspect, in the discharging process of the second step, the area of the forming material which is deposited directly under the nozzle is expanded by an amount corresponding to the amount by which the movement speed of the nozzle is reduced. Therefore, it is possible to reduce the movement distance of the nozzle for depositing the forming material inside the recessed portion in the second step and it is possible to form the second formed part which has a higher density structure. Accordingly, it is possible to increase the forming precision while shortening the forming time of the three-dimensional formed object.

(3) In the manufacturing method of the aspect, in the discharging process of the first step, a discharge amount of the forming material from the nozzle may be reduced when modifying a movement direction of the nozzle with respect to the forming table, and in the discharging process of the second step, the discharge amount of the forming material from the nozzle may not be reduced to less than that in the first step when modifying the movement direction of the nozzle with respect to the forming table.

According to the manufacturing method of the aspect, since the control of the discharge amount of the forming material in the second step of forming the second formed part is simplified as compared to that in the first step of forming the first formed part, it is possible to shorten the forming time of the second formed part. Accordingly, it is possible to more swiftly form the three-dimensional formed object.

(4) In the manufacturing method of the aspect, in the discharging process of the second step, a speed of revolution of the flat screw may be increased as compared to that in the first step.

According to the manufacturing method of the aspect, it is possible to render the forming time of the second formed part shorter than the forming time of the first formed part using simpler control of the speed of revolution of the flat screw.

(5) In the manufacturing method of the aspect, a first nozzle may be used as the nozzle in the discharging process of the first step and a second nozzle which has a larger bore diameter of a discharge port than the first nozzle may be used as the nozzle in the discharging process of the second step.

According to the manufacturing method of the aspect, it is possible to render the forming time of the second formed part shorter than the forming time of the first formed part by exchanging the nozzle for a nozzle having a different bore diameter.

(6) In the manufacturing method of the aspect, the second step may include a step of disposing a structure which configures a portion of the second formed part inside the recessed portion, and a step of causing the forming material to be deposited through the discharging process in a space in which the structure is not disposed inside the recessed portion.

According to the manufacturing method of the aspect, due to the structure, it is possible to reduce the volume of the part which is formed in the discharging process of the second step and it is possible to easily render the forming time per unit volume of the second formed part shorter than the forming time per unit volume of the first formed part.

(7) The second aspect is provided as a forming apparatus which forms a three-dimensional formed object. The forming apparatus of the aspect includes a material generating unit which includes a flat screw and which melts at least a portion of a material which is supplied to the rotating flat screw to generate a forming material, a nozzle which discharges the forming material toward a top surface of the forming table, a movement mechanism which modifies a relative position between the forming table and the nozzle, and a control unit which executes a discharging process which causes the forming material to be discharged from the nozzle onto the top surface of the forming table while controlling the movement mechanism to change the relative position between the forming table and the nozzle, in which the control unit (i) causes the forming material to be deposited on the forming table through the discharging process to form a first formed part which includes a recessed portion which is open in a direction heading from the forming table toward the nozzle, and (ii) executes at least a process of causing the forming material to be deposited inside the recessed portion through the discharging process and forming a second formed part which is fixed to the inside of the recessed portion in a shorter forming time per unit volume than a forming time per unit volume of the first formed part.

According to the forming apparatus of the aspect, it is possible to control the discharging of the forming material at high precision while easily generating the fluid forming material with a miniature apparatus configuration by using the flat screw. Accordingly, even in a case in which the material which is prepared in a solid state is used, it is possible to swiftly form the three-dimensional formed object at high precision using simpler steps and configurations. Since it is possible to shorten the forming time of the second formed part which configures the structure of the inner portion of the three-dimensional formed object and for which high forming precision is not demanded in comparison to the first formed part, it is possible to swiftly form the three-dimensional formed object.

It is also possible to realize the invention in various aspects other than the manufacturing method or the forming apparatus of the three-dimensional formed object. For example, it is possible to realize the invention in aspects such as a three-dimensional formed object which is formed using the manufacturing methods or forming apparatuses, a control method of the forming apparatus, a control device of the forming apparatus, a deposition method of the forming material which configures the three-dimensional formed object, or the like. It is possible to realize the invention using aspects such as a computer program for realizing the methods and control methods described earlier, a non-transitory storage medium on which the computer program is recorded, or the like.

What is claimed is:

1. A manufacturing method of a three-dimensional formed object, the method comprising:
a first step of causing a forming material to be deposited on a forming table to form a first formed part including a recessed portion which is open in a direction heading from the forming table toward a nozzle through a discharging process of supplying a material to a rotating flat screw to generate the forming material in which at least a portion of the material is melted and discharging the forming material from the nozzle toward the forming table while changing a relative position between the forming table and the nozzle; and
a second step, including a step of causing the forming material to be deposited inside the recessed portion through the discharging process, of forming a second formed part which is fixed to the inside of the recessed portion in a shorter forming time per unit volume than a forming time per unit volume of the first formed part.

2. The manufacturing method according to claim 1,
wherein in the second step, an area on which the forming material is deposited under the nozzle is rendered larger than in the first step by rendering a movement speed of the nozzle with respect to the forming table in the discharging process lower than that in the first step.

3. The manufacturing method according to claim 1,
wherein in the discharging process of the first step, a discharge amount of the forming material from the nozzle is reduced when modifying a movement direction of the nozzle with respect to the forming table, and
wherein in the discharging process of the second step, the discharge amount of the forming material from the nozzle is not reduced to less than that in the first step when modifying the movement direction of the nozzle with respect to the forming table.

4. The manufacturing method according to claim 1,
wherein in the discharging process of the second step, a speed of revolution of the flat screw is increased as compared to that in the first step.

5. The manufacturing method according to claim 1,
wherein a first nozzle is used as the nozzle in the discharging process of the first step and a second nozzle which has a larger bore diameter of a discharge port than the first nozzle is used as the nozzle in the discharging process of the second step.

6. The manufacturing method according to claim 1,
wherein the second step includes
a step of disposing a structure which configures a portion of the second formed part inside the recessed portion, and
a step of causing the forming material to be deposited through the discharging process in a space in which the structure is not disposed inside the recessed portion.

7. A forming apparatus which forms a three-dimensional formed object, the apparatus comprising:
a material generating unit which includes a flat screw and which melts at least a portion of a material which is supplied to the rotating flat screw to generate a forming material;
a nozzle which discharges the forming material toward a top surface of the forming table;
a movement mechanism which modifies a relative position between the forming table and the nozzle; and
a control unit which executes a discharging process which causes the forming material to be discharged from the nozzle onto the top surface of the forming table while controlling the movement mechanism to change the relative position between the forming table and the nozzle,
wherein the control unit
(i) causes the forming material to be deposited on the forming table through the discharging process to form a first formed part which includes a recessed portion which is open in a direction heading from the forming table toward the nozzle, and
(ii) executes at least a process of causing the forming material to be deposited inside the recessed portion through the discharging process and forming a second formed part which is fixed to the inside of the recessed portion in a shorter forming time per unit volume than a forming time per unit volume of the first formed part.
